(19) United States
(12) Patent Application Publication
(10) Pub. No.: US 2026/0330192 A1
(43) Pub. Date: Oct. 22, 2026

(54) AI MODEL FINE-TUNING WITH A REWARD MODEL ITERATIVELY TRAINED ON TARGETED HUMAN FEEDBACK

(71) Applicant: Microsoft Technology Licensing, LLC, Redmond, WA (US)

(72) Inventors: Tusher CHAKRABORTY, Bellevue, WA (US); Ranveer CHANDRA, Kirkland, WA (US); Emre Mehmet KICIMAN, Seattle, WA (US); Yifei XU, Los Angeles, CA (US)

(73) Assignee: Microsoft Technology Licensing, LLC, Redmond, WA (US)

(21) Appl. No.: 19/182,816

(22) Filed: Apr. 18, 2025

(51) Int. Cl. G06N 3/0475; G06F 40/40; G06N 3/0455; G06Q 30/0207

(52) U.S. Cl. CPC G06N 3/0475; G06F 40/40; G06N 3/0455; G06Q 30/0224

(57) ABSTRACT

A data processing system implements prompting a first GenAI model to label a dataset into preference pairs based on a task and preference judgement criteria; using a second GenAI model to generate an initial reward model (RM) by modeling a reward score difference for each preference pair as a reward distribution curve that ranks each preference pair; training adapters of the second model to iteratively train the initial RM by: identifying on the curve a first portion including first pairs hard for the first model to correctly label, and a second portion including positive pairs ranked higher than the first pairs, and updating the curve for a subsequent iteration RM based on an improved dataset including the positive pairs and human annotated data generated from the first pairs; and fine-tuning the first model based on either a last iteration RM or an improved dataset associated with the last iteration RM.

### BACKGROUND

Artificial intelligence (AI) has been applied to automate our lives to optimize resource allocation and increase productivity. For instance, Reinforcement Learning from Human Feedback (RLHF) is used to fine-tune a large language model (LLM) for a resource allocation task (e.g., resource allocation) based on human feedback. Since high-quality human annotations are costly and time-consuming, Reinforcement Learning from AI Feedback (RLAIF) was introduced to replace human annotations with AI annotations. Besides cost concerns, privacy and security concerns of customer data corpus, especially enterprise data, further drive towards AI annotations. However, RLAIF cannot fully replace human annotations with AI annotations, since RLAIF is sensitive to factors like prompt optimization, task complexity, model bias, generator-discriminator gap, the capability of the judge model, and the like. Hence, there is a need for improving systems and methods of fine-tuning an AI model with a reward model iteratively trained on minimum human annotations yet with quality close to full human-annotations.

### SUMMARY

An example data processing system according to the disclosure includes a processor and a machine-readable medium storing executable instructions. The instructions when executed cause the processor alone or in combination with other processors to perform operations including prompting a first generative AI model to label an unlabeled dataset into a plurality of preference pairs based on instructions of a task and one or more preference judgement criteria; inputting the preference pairs to a second generative AI model; using the second generative AI model as a based model to generate an initial reward model by modeling reward scores for each of the preference pairs, and generating a reward distribution curve of the initial reward model that ranks each of the preference pairs by a reward score difference of a respective preference pair; training adapters of the second generative AI model to iteratively train the initial reward model into a last iteration reward model by: automatically identifying a first portion and a second portion on the reward distribution curve, wherein the first portion includes first pairs that are hard for the first generative AI model to correctly label, and the second portion includes positive pairs ranked higher as compared to the first pairs, outputting the first pairs in the first portion for human annotations as annotated data, inputting the annotated data into an improved dataset including the positive pairs in the second portion, and updating the reward distribution curve for a subsequent iteration reward model based on the improved dataset; and fine-tuning the first generative AI model by either incorporating the last iteration reward model into a PPO loop, or inputting an improved dataset associated with the last iteration reward model into a DPO pipeline.

An example method implemented in a data processing system includes prompting a first generative AI model to label an unlabeled dataset into a plurality of preference pairs based on instructions of a task and one or more preference judgement criteria; inputting the preference pairs to a second generative AI model; using the second generative AI model as a base model to generate an initial reward model by modeling reward scores for each of the preference pairs, and generating a reward distribution curve of the initial reward model that ranks each of the preference pairs by a reward score difference of a respective preference pair; training adapters of the second generative AI model to iteratively train the initial reward model into a last iteration reward model by: automatically identifying a first portion and a second portion on the reward distribution curve, wherein the first portion includes first pairs that are hard for the first generative AI model to correctly label, and the second portion includes positive pairs ranked higher as compared to the first pairs, outputting the first pairs in the first portion for human annotations as annotated data, inputting the annotated data into an improved dataset including the positive pairs in the second portion, and updating the reward distribution curve for a subsequent iteration reward model based on the improved dataset; and fine-tuning the first generative AI model by either incorporating the last iteration reward model into a PPO loop, or inputting an improved dataset associated with the last iteration reward model into a DPO pipeline.

An example non-transitory computer readable medium data processing system according to the disclosure on which are stored instructions that, when executed, cause a programmable device to perform functions of prompting a first generative AI model to label an unlabeled dataset into a plurality of preference pairs based on instructions of a task and one or more preference judgement criteria; inputting the preference pairs to a second generative AI model; using the second generative AI model as a base model to generate an initial reward model by modeling reward scores for each of the preference pairs, and generating a reward distribution curve of the initial reward model that ranks each of the preference pairs by a reward score difference of a respective preference pair; training adapters of the second generative AI model to iteratively train the initial reward model into a last iteration reward model by: automatically identifying a first portion and a second portion on the reward distribution curve, wherein the first portion includes first pairs that are hard for the first generative AI model to correctly label, and the second portion includes positive pairs ranked higher as compared to the first pairs, outputting the first pairs in the first portion for human annotations as annotated data, inputting the annotated data into an improved dataset including the positive pairs in the second portion, and updating the reward distribution curve for a subsequent iteration reward model based on the improved dataset; and fine-tuning the first generative AI model by either incorporating the last iteration reward model into a PPO loop, or inputting an improved dataset associated with the last iteration reward model into a DPO pipeline.

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter. Furthermore, the claimed subject matter is not limited to implementations that solve any or all disadvantages noted in any part of this disclosure.

### BRIEF DESCRIPTION OF THE DRAWINGS

The drawing figures depict one or more implementations in accord with the present teachings, by way of example only, not by way of limitation. In the figures, like reference numerals refer to the same or similar elements. Furthermore, it should be understood that the drawings are not necessarily to scale.

FIG. 1 is a diagram of an example computing environment in which the techniques for AI model fine-tuning with a reward model iteratively trained on targeted human feedback are implemented.

FIG. 2 is a conceptual diagram of Reinforcement Learning from Targeted Human Feedback (RLTHF) for AI model fine-tuning with a reward model iteratively trained on targeted human feedback implemented by the application services platform shown in FIG. 1.

FIGS. 3A-3D are diagrams of reward distribution curves associated with training a reward model and correctness distribution curves with regard to full-human preference for the initial and fifth/last iterations of RLTHF described herein.

FIG. 4 is a flow chart of an example process for AI model fine-tuning with a reward model iteratively trained on targeted human feedback according to the techniques disclosed herein.

FIG. 5 is a block diagram showing an example software architecture, various portions of which may be used in conjunction with various hardware architectures herein described, which may implement any of the described features.

FIG. 6 is a block diagram showing components of an example machine configured to read instructions from a machine-readable medium and perform any of the features described herein.

### DETAILED DESCRIPTION

Systems and methods for AI model fine-tuning with a reward model iteratively trained on targeted human feedback are described herein. These techniques provide a technical solution to the technical problems of human annotations (e.g., RLHF) and AI-powered preference annotation (e.g., RLAIF), via AI model fine-tuning with a reward model iteratively trained on targeted human feedback. The technical solution of RLTHF combines LLM based initial alignment with selective human annotations to reach full-human annotation-level alignment with only 6-7% of the human annotation effort.

Referring to the technical problems of RLHF discussed in the Background section, RLHF has two key components: reward learning and policy optimization, which work together to align AI behavior with human preferences. The human feedback is used to create a learned reward function that approximates human preferences. A reward model is trained to interpret human feedback and assign a reward score to Al's actions. RLHF relies on real human preferences for training its reward model. However, human annotation is expensive, time-consuming, and error prone.

AI-generated annotations (e.g., RLAIF) become popular due to time and cost savings, as well as data privacy and security enhancement. A lot of times, an enterprise data preparation process requires involvement of external data/applied scientists. Some enterprise customers want the external data/applied scientists to prepare enterprise data for AI-model fine-tuning in an eyes-off manner in order to preserve customer data privacy. Preferably, the generative AI model fine-tuning involves inputs and feedback from subject matter experts (e.g., tenant administrative staffs) at the customer side, and eliminates data exposure to any external data/applied scientists.

However, as mentioned, RLAIF has technical problems like being highly sensitive to multiple factors that affect the quality of its preference annotations and overall learning dynamics. For example, prompt optimization can skew AI-generated preferences, as small changes in wording may lead the generative AI model to produce vastly different outputs, affecting the reliability of annotations. Simple tasks may be well-approximated by AI feedback, while complex or nuanced tasks (e.g., ethical reasoning) may suffer from misalignment due to the AI's limited understanding. Model bias is another concern, as the reward model learns from AI-generated data, potentially reinforcing existing biases in a feedback loop. The generator-discriminator gap refers to the discrepancy between the generative AI model generating responses and the reward model evaluating them. When this gap is too large, the reward model may fail to correctly rank outputs, leading to suboptimal learning. Finally, the capability of the judge model (i.e., the AI evaluating preferences) directly impacts annotation quality. A weak judge may struggle with fine-grained distinctions, leading to poor preference signals, while an overly strong judge might overfit to patterns not representative of human values. Together, these factors make RLAIF highly sensitive to setup choices, potentially affecting alignment, robustness, and generalization.

To address these technical problems, a technical solution of a human-AI hybrid solution named RLTHF is proposed. RLTHF combines coarse initial alignment using a generative AI model (e.g., a LLM) with iterative targeted human annotations to achieve quality comparable to full human annotations. RLTHF begins with building an initial reward model, where the LLM labels unlabeled data based on high-level instructions. RLTHF then automatically identifies hard-to-annotate data points in the reward model and directs human effort on these data points. This targeted approach enables RLTHF to achieve the quality of fully human-annotated data using minimum human annotation effort.

In one implantation, the LLM labels unlabeled dataset. RLTHF builds an initial reward model for summarizing data based on the labelled dataset. RLTHF trains the reward model to identify and prioritize hard, low-confidence samples based on a reward-rank curve in the initial reward model for human annotations, and then progressively infuses domain knowledge via the human annotations into the reward model. RLTHF then fine tunes the LLM using the last iteration reward model for summarizing data.

Although various embodiments are described with respect to fine-tuning LLMs, it is contemplated that the technical solution described herein may be applied to fine-tuning other generative models (e.g., vision models) for tasks, depending on the input and output data type/format requirements (e.g., text, audio, diagrams, videos, and the like) as well as other considerations. Although various embodiments are described with respect to fine-tuning an AI model to summarize data, it is contemplated that the technical solution described herein may be applied to fine-tune an AI model for any other tasks, such as enterprise-level AI requests in subject matter areas (e.g., analysis of legal documents, corporate policy, HR questions), where there are limited annotate data, strict business objectives and restricted data visibility due to privacy and regulatory compliance.

A technical benefit of RLTHF provided herein is to support entities (e.g., enterprises, end users, etc.) to fine-tune a generative AI model for a task by strategically integrating AI-generated labels with selective human annotations to maximize alignment with human preferences with minimum human annotation efforts, by iteratively refining a reward model and exposes human annotators to diverse, AI-mislabeled samples.

Another technical benefit of RLTHF provided herein is to support an external entity to fine-tune generative AI models for different tasks (e.g. analysis of legal documents, corporate policy, HR questions, and the like) of an enterprise customer in an “eyes-off” manner, where there are limited annotate data, strict business objectives, and restricted data visibility due to privacy and regulatory compliance.

Another technical benefit of RLTHF provided herein is to employ random sharding to down-sample the original corpus, by selecting a random shard of the dataset, iteratively improving alignment within that subset, and labeling the entire corpus with the final iteration's reward model. This sharding enables RLTHF to concentrate human annotations in a smaller, more targeted space while effectively propagating alignment across the full dataset at the end.

Another technical benefit of RLTHF provided herein is to enhance human preference alignment in datasets used for training preference optimization techniques like proximal policy optimization (PPO) which optimizes a generative AL model with a separate reward model, direct preference optimization (DPO) which directly learns from preference data, and the like.

Yet another technical benefit of RLTHF provided herein is to facilitate generative AI model fine-tuning for various downstream tasks, including summarization, compliance, grounding, and the like. These and other technical benefits of the techniques disclosed herein will be evident from the discussion of the example implementations that follow.

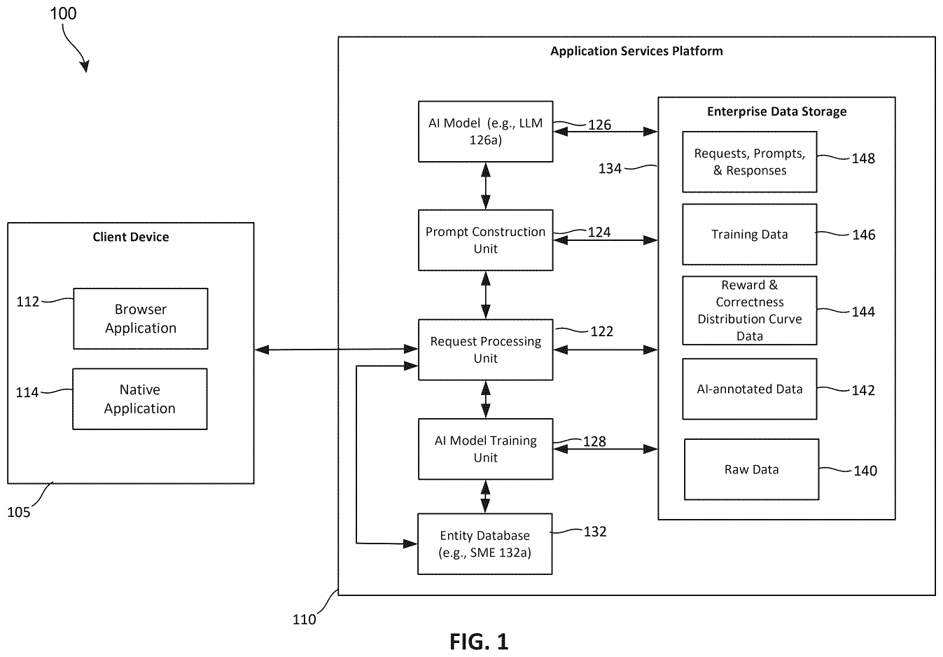

FIG. 1 is a diagram of an example computing environment 100 in which the techniques herein may be implemented. The example computing environment 100 includes a client device 105 and an application services platform 110. The application services platform 110 provides one or more cloud-based applications and/or provides services to support one or more web-enabled native applications on the client device 105. These applications may include but are not limited to AI model fine-tuning applications (e.g., M365 Copilot®), presentation applications, website authoring applications, collaboration platforms, communications platforms, and/or other types of applications in which users may fine-tune an AI model for different tasks. In the implementation shown in FIG. 1, the application services platform 110 also applies generative AI to generate fast and accurate task outputs upon user demand according to the techniques described herein.

In one embodiment, the application services platform 110 is independently implemented on the client device 105. In another embodiment, the client device 105 and the application services platform 110 communicate with each other over a network (not shown) to implement the system. The network may be a combination of one or more public and/or private networks and may be implemented at least in part by the Internet.

The client device 105 is a computing device that may be implemented as a portable electronic device, such as a mobile phone, a tablet computer, a laptop computer, a portable digital assistant device, a portable game console, and/or other such devices in some implementations. The client device 105 may also be implemented in computing devices having other form factors, such as a desktop computer, vehicle onboard computing system, a kiosk, a point-of-sale system, a video game console, and/or other types of computing devices in other implementations. While the example implementation illustrated in FIG. 1 includes a single client device 105, other implementations may include a different number of client devices that utilize services provided by the application services platform 110.

The client device 105 includes a native application 114 and a browser application 112. The native application 114 is a web-enabled native application, in some implementations, which enables users to view, create, and/or modify summarized content. The web-enabled native application utilizes services provided by the application services platform 110 including but not limited to obtaining summarized content data, and fine-tuning an AI model for summarizing various types of content using the summarized content data. The native application 114 implements a user interface for an AI chatbot to receive user requests for summarizing various types of content in some implementations. In other implementations, the browser application 112 is used for accessing, viewing, and/or summarizing web-based content provided by the application services platform 110. In such implementations, the application services platform 110 implements one or more web applications, such as the browser application 112, that enables users to fine-tune an AI model for different tasks, including content summarization. The browser application 112 implements the user interface in some implementations. The application services platform 110 supports both the native application 114 and the browser application 112 in some implementations, and the users may choose which approach best suits their needs.

In one embodiment, the application services platform 110 includes a request processing unit 122, a prompt construction unit 124, an AI model 126, and an AI model training unit 128. In other embodiments, the application services platform 110 also includes an entity database 132, an enterprise data storage 134, and/or moderation services.

The request processing unit 122 is configured to receive requests from the native application 114 and/or the browser application 112 of the client device 105. The requests may include but are not limited to requests to fine-tune an AI model 126 for a downstream task (e.g., social forum post summarization) and/or sending natural language prompts to the AI model 126 to generate a summarized content item using the fine-tuned model according to the techniques provided herein. The AI model 126 can be selected for a use case considering the specific knowledge base, the availability of pre-trained models, and the like. The request processing unit 122 also coordinates communication and exchange of data among components of the application services platform 110 as discussed in the examples which follow.

The prompt construction unit 124 is responsible for creating and refining prompts to interact effectively with the AI model 126. This involves designing input instructions that guide the AI model 126 to produce accurate and contextually relevant outputs. The key tasks of the prompt construction unit 124 in the RLTHF include working in conjunction with the AI model training unit 128 to construct prompts to an AI model (e.g., an LLM 126a) to build an initial reward model, to iteratively train the reward model, to optimize the policy of the LLM 126a based on a last iteration reward model, and the like. For example, in response to a user request, the prompt construction unit 124 calls the fined-tuned LLM 126a to summarize a given social forum post.

In one embodiment, the AI model 126 is a language model trained to summarize content (e.g., textual, spreadsheet, chart, report, audio, image, video, and the like) in response to natural language prompts input by a user via the native application 114 or via the web. For instance, the AI model 126 is implemented using a LLM in some implementations. Examples of such models include but are not limited to Generative Pre-trained Transformer 4 (GPT-4), Claude®, BERT® (Bidirectional Encoder Representations from Transformers), Falcon 40B®, Gemini®, CodeWhisperer®, and the like. Other implementations may fine-tune other generative models (such as LMMs) for tasks according to the RLTHF. The LMMs can be GPT-40, DALL-E 2, Llama 3, ImageBind®, LLaVAR, Gemini®, Florence®, Claude®, NVLM®, and the like.

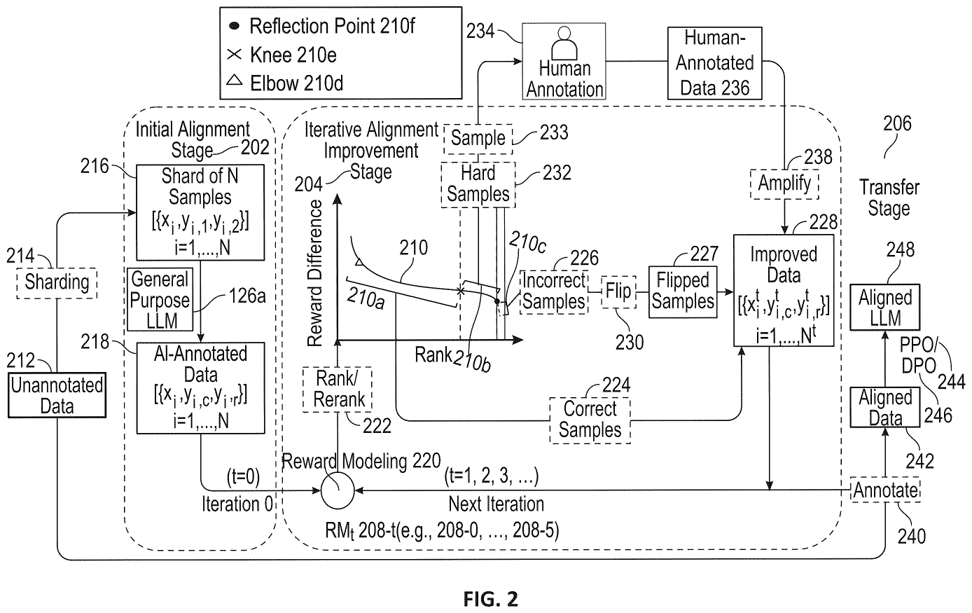

The AI model training unit 128 performs many functions of the RLTHF. In one implementation, a user (e.g., a software developer) activates a command line interface (CLI) tool on a user interface of the client device 105, and then inputs via the CLI a user request to fine-tune the LLM 126a for a content summarization task (e.g., summarizing a given social forum post). The request processing unit 122 receives the user request and transmits the request to the AI model training unit 128. For instance, the AI model training unit 128 implements the RLTHF using python. FIG. 2 is a conceptual diagram of applying the RLTHF for fine-tuning the AI model 126 for tasks implemented by the application services platform 110, using data retrieved from the enterprise data storage 134. For instance, the enterprise data storage 134 stores content data 140, raw summarized content data 142, synthetic summarized content data 144, training data 146, and requests, prompts and responses 148.

FIG. 2 is a conceptual diagram of the RLTHF process for AI model fine-tuning with a reward model iteratively trained on targeted human feedback implemented by the application services platform shown in FIG. 1. RLTHF starts with coarse LLM alignment on a task. It then iteratively takes targeted human feedback to reach the complete human alignment, by leveraging reward distribution of a reward model in its training dataset.

The AI model training unit 128 applies the RLTHF in FIG. 2 to fine-tune a general-purpose LLM (e.g., the LLM 126a) in response to the user request to fine-tune the LLM 126a for the content summarization task. The RLTHF consists of three stages. The first stage includes a reward model initial alignment stage 202. In the initial alignment stage 202, the LLM 126a labels a dataset to establish a coarse understanding of the dataset for a task. In one implementation, the dataset may include paired reddit post summaries, match samples between paired competing sports teams, and the like. In keeping with the previous example, the coarse understanding of the dataset for a task my include selecting a user-preferred reddit post summary form a pair, predicting winning teams of coming matches, and the like.

The second stage of the RLTHF includes a reward model iterative alignment stage 204. This stage leverages a reward distribution of a reward model to locate and rectify hard-to-annotate samples mislabeled by the LLM 126a with selective human feedback while investing the correct LLM labels.

The third stage of RLTHF includes a knowledge transfer stage 206. The knowledge transfer stage 206 transfers RLTHF outputs to downstream tasks. RLTHF assumes that the LLM 126a lacks comprehensive alignment with the user's preferences, and builds upon an initial AI-provided alignment and systematically refines it in subsequent stages to achieve close to full human annotation alignment. Although RLTHF is not sensitive to the choice of the LLM, a well-suited model can accelerate alignment convergence. The LLM 126a should possess a basic understanding of a task of interest, enabling it to provide a rough initial alignment that serves as a seed for RLTHF.

During the reward model initial alignment stage 202, the LLM 126a obtains preference judgments on unannotated data 212 to obtain AI-annotated data 218 using a prompt listed in Table 1. The prompt includes (1) task description, (2) preference judgment principles provided by the user, and (3) few-shot examples with optional chain-of-thought (CoT) reasoning. Typically, the LLM 126a (i.e., an AI annotator) ranks multiple responses (e.g., Response A, Response B being two summaries of a given reddit post) generated by the LLM 126a for a given prompt (e.g., the prompt in Table 1), indicating which outputs are preferred. This ranked data is then used to build an initial reward model, and then to iteratively train the initial reward model. The trained reward model learns to assign numerical reward scores to different outputs of the LLM 126a based on how well they align with human preferences. This learned reward function serves as a proxy for human judgment, allowing automated evaluation of the LLM's responses. RLTHF may not perform explicit fine-grained prompt tuning, as full visibility into the data may be restricted when offering fine-tuning services to third-party customers. However, to ensure that the LLM 126a and the prompt attains a reasonable level of alignment, RLTHF performs an eyes-off validation using strategic human feedback, as detailed later.

TABLE 1
## TASK
Summarize the given reddit post.
-------------------------------------------------
## CRITERIA
What makes for a good summary? Roughly speaking, a good summary is a shorter piece of
text that has the essence of the original - tries to accomplish the same purpose and conveys
the same information as the original post. We would like you to consider these different
dimensions of summaries:
**Essence:** is the summary a good representation of the post?
**Clarity:** is the summary reader-friendly? Does it express ideas clearly?
**Accuracy:** does the summary contain the same information as the longer post?
**Purpose:** does the summary serve the same purpose as the original post?
**Concise:** is the summary short and to-the-point?
**Style:** is the summary written in the same style as the original post?
Generally speaking, higher weight is given to the dimensions at the top of the list. Things
are complicated though - none of these dimensions are simple yes/no matters, and there are
not hard and fast rules for trading off different dimensions.
-------------------------------------------------
## INPUT
{input}
-------------------------------------------------
## CANDIDATE RESPONSES
**Response A**: {response a}
**Response B**: {response b}
## INSTRUCTIONS
1. Review the task, criteria, and input thoroughly.
2. Evaluate each response based on how well it aligns with the criteria.
3. Decide which response (A or B) is better aligned with the criteria.
4. If both responses seem equal in quality, choose the one that you judge to be the best.
5. Provide your answer in the following format:
rationale: <Your concise reasoning>
preference: “Response A” or “Response B”

Optionally, the unannotated data 212 is processed via a sharding step 214 to be randomly sharded (e.g., down-sampled ¼ shard) into N samples 216, thereby increasing annotation efficiency. In this case, the initial alignment stage 202 begins with annotating the randomly selected shard of the dataset into the AI-annotated data 218, then sends the AI-annotated data 218 to the next stage 204 for iterative alignment. For instance, the LLM 126a runs the prompt in Table 1 on the N samples 216 (e.g., [{xi, yi,1, yi,2}], i=1, . . . , N) to obtain AI-annotated data 218 (e.g., the labeled preference dataset [{xi, yi,c, yi,r}], i=1, . . . , N).

During the reward model iterative alignment stage 204, the RLTHF develops the initial reward model 208-0 to leverage a reward distribution curve 210 over a training dataset (e.g., unannotated data 212) to capture the relative arrangement of samples based on rewarded features. For example, the unannotated data 212 required for the fine-tuning is embedded in a tenant corpus in unlabeled and unstructured manner.

Optionally, RLTHF validates the initial reward model 208-0 using a preference dataset filtered by the LLM 126a before iteratively training the initial reward model 208-0. This dataset is denoted as [symbol] ΛLLM, where ΛLLM represents the preference labeling performed by the LLM 126a. The validation dataset derived from [symbol] ΛLLM ensures that the trained reward model is broadly aligned with the LLM's preferences, so that the LLM 126a has a coarse but reasonable understanding of preference judgments, particularly for relatively easy-to-annotate samples. The features of these samples dominate the reward differences. An upper left region 210a of the reward density curve 210 contains high density of samples with prominent preference features, i.e., easier for the LLM 126a to label/annotate accurately. Before proceeding, the system validates that the LLM 126a is at least roughly aligned with the end-user's preferences in terms of these easy-to-annotate samples. This step mitigates the risk of significant misalignment due to prompt curation or model selection. To achieve this, RLTHF automatically samples a small subset (e.g., <0.1%) of preference data from the upper left region 210a to gather human annotations. When human agreement on these samples is low, it signals a major misalignment between the user's preferences and the LLM's outputs. This issue can be addressed by refining the judgment principles in the prompt. Updates can be made directly by the user, by incorporating detailed/extensive user feedback, or even through automated prompt optimization techniques.

Suppose there is a set of entities (e.g., teams in a tournament), and pairwise matchups where one entity wins over another. Given a labeled preference dataset [symbol] Λ={xi, yi,c, yi,r}, where i∈[N], xi is the prompt, yi,c and yi,r denote the chosen and rejected completions, respectively, as labeled according to the AI annotator's preference, Λ. When representing the relative preference orientation of ith completion pair with λ=[−1,+1], Λ is a N-dimensional vector consists of

$${[ {λ}_{i} ]}_{i = 1}^{N} ,$$

meaning that mapping the preferences of all completion pairs results in [symbol] −Λ. To train a reward model on this dataset, the probability distribution of yi,c is formulated as preferred over yi,r given xi as an input, following a pairwise comparison probabilistic model (e.g., the Bradley-Terry (BT) model) in formula (1).

P(x>y)=σ(r(xᵢ,y_{{i,c}})−r(xᵢ,y_{{i,r}})) (1)
where σ(⋅) denotes the sigmoid function and r (⋅) denotes the reward function. The BT model is a probabilistic model used for pairwise comparisons to estimate the relative strengths or abilities of different entities (e.g., players, teams, or items). It is widely applied in ranking systems, sports competitions, and preference modeling. Assuming a true deterministic reward function exists, the goal is to train the reward model to learn this function and predict the reward, \hat{r} (x, y). The reward model training can be framed as a binary classification problem, where a labeled preference pair of ρi,c:=(xi, yi,c) and ρi,r:=(xi, yi,r) is passed to the model to predict the conditional class probability according to formula (1). This leads to the negative log-likelihood loss function for training as in formula (2).

[symbol]

(\hat{r})=− [symbol] [log(σ(\hat{r}(ρ_{i,c})−(\hat{r}(ρ_{i,r})] (2)

In essence, during the reward model training, a labelled preference pair {ρi,c, ρi,r} is passed as ρi,c winning over ρi,r according to the annotator's preference A. For example, Team A is predicted by the LLM 126a to win over Team B, or Summary C is preferred over Summary D by the LLM 126a. Provided sufficient preference samples in a dataset, the reward model learns winning preference features of the dataset that determine the winner in a pair, as captured in the reward function \hat{r}Λ.

Referring back to the winning sports team example, the features/characteristics of a sports team contributing towards a win can be star players, experienced players, strong teamwork, clear communication, effective strategies and adaptability, strong leadership from coaches and captains, rigorous training, home advantage, fan support, and the like. The rewarded features are included in an embedding space of a generative AI model and/or the reward model. A reward model has an embedding space which function differs from that of a generative AI model. A generative AI model embedding space stores dense vector representations of words, sentences, or entire documents, captures semantic meaning, syntactic structure, and contextual relationships, and facilitates in generating coherent and contextually relevant text. A reward model embedding space stores feature representations of input text (or other data), and facilitates evaluating and distinguishing preferred vs. dispreferred outputs, thereby scoring or ranking outputs based on alignment with human preferences. A generative AI model uses embeddings to produce diverse and meaningful outputs, whereas a reward model maps inputs to a reward signal. The LLM's embeddings aim for fluency and coherence, while the reward model's embeddings help distinguish between high-quality and low-quality responses. In reinforcement learning, the reward model helps fine-tune an LLM (e.g., using PPO or DPO) by guiding it toward preferred outputs.

In iteration 0, a reward modelling step 220 starts with using another generative AI model (e.g., Llama) as a foundation (i.e., a based model) for training the reward model. In one implementation, low-rank adaptation (LoRA) adapters are attached to the attention projection matrices of the other generative AI model. In later iterations, only these adapters are trained with preference data while keeping the rest of the model fixed. A loss function is used to encourage the reward model to predict the correct preferences. Different LoRA parameters can be experimented with to find the optimal settings for different tasks.

In iteration 0, the AI-annotated data 218 is used to model per sample reward differences (e.g., measuring differences of the teams' winning features), ranks the N samples 216 based on their reward differences (i.e., a rank/reranking step 222), and plots the reward distribution curve 210 of AI-annotated preferences for each sample into an initial reward model 208-0. For each later iteration, the samples are filtered then re-ranked to provide an updated reward distribution curve 210 as the new iteration reward model 208-t. For each labeled preference pair {ρi,c, ρi,r} in the AI-annotated data 218, the reward score difference or reward difference is computed as ΔΛ\hat{r}Λ=(\hat{r}Λ(ρc)\hat{r}Λ(ρr)). ΔΔ quantifies the relative preference score of a given pair in alignment with the annotator's preference orientation Λ, satisfying the property ΔΛr=−Λ−Λr. The values and ranges of the reward scores and the reward score differences can be arbitrarily set by a user and/or the system based on a dataset size, the task (e.g., predicting winning sports teams, user-preferred social forum post summaries, and the like), and other considerations.

By ranking all preference pairs in [symbol] Λ based on ΔΛ\vec{r}Λ, a monotonic reward distribution curve, denoted as ∂(ΔΛ\hat{r}Λ), emerges. The reward distribution curve 210 has rank on the x axis and the reward different on the y axis, to show how much the reward model 208 is aligning with the LLM annotator's preferences. The reward distribution curve 210 in FIG. 2 provides insight into reward assignments across the dataset. Referring back to the sports team example, Team 1 gets score 10 for one experienced player, Team 2 gets score 4 for one little bit less experienced player. So the reward score difference of their experienced players is 6. There are hundreds of other features for the LLM 126a to learn from the dataset and calculate reward difference scores, in order to plot the reward distribution curve 210.

To estimate the boundaries of key regions within the reward distribution curve 210, the system identifies two strategic points: an “elbow” 210d and a “knee” 210e, as illustrated in the chart in FIG. 2. These points correspond to sharp changes in reward score differences, which are detected using the first-order derivative. The knee 210e marks the transition to a region with a negative reward differences (e.g., very confident as incorrect), whereas the elbow 210d indicates a shift toward higher reward differences (e.g., very confident as correct). These points serve as rough estimations of the region boundaries rather than precise demarcations. In one implementation, the upper left region 210a of the reward distribution curve 210 is defined as the portion/section above the elbow 210d, and the super positive samples of the upper left region 210a are directly included as the improved data for the next training iteration of the reward model 208. In another implementation, the upper left region 210a of the reward distribution curve 210 is defined as the portion/section above the knee 210e, thus more samples (e.g., true positive samples) are directly included as the improved data for the next training iteration of the reward model 208

In one implementation, a bottom right region of the reward distribution curve 210 is defined as the portion/section below the knee 210e (e.g., a hard-to-annotated portion 210b). Some samples in this region/portion are sent for human annotations, while other samples in this region/portion exhibit preference features that are largely opposite to the dominant features captured by the LLM 126a. These samples are highly likely to be mislabeled by the LLM 126a. Instead of applying human annotations, these incorrect samples 226 of the bottom right region can be simply flipped into flipped samples 227 to correct the mislabeling in a flip step 230 (e.g., a winning team becoming a losing team). The flipped data is then included as a new training dataset (i.e., improved data 228, e.g., [{xti, yti,c, yti,r}], i=1, . . . , Nt) for the next training iteration of the reward model 208.

To estimate the position of a flipping region 210c on the reward distribution curve 210, the system takes the reflection of the elbow 210d across the x-axis as a reflection point 210f, and the flipping region 210c is set from the reflection point 210f to the right end of the reward distribution curve 210. This reflection point 210f always lies to the right of the knee 210e in the lowest reward score difference region. Human annotations 234 are applied for hard samples 232 between the knee 210e and the reflection point 210f, then the human-annotated data 236 is included in the new training dataset (i.e., the improved data 228) for the next training iteration of the reward model 208.

In an optional step 233, random samples are taken from the hard samples 232 (rather than taking all of the hard samples 232) for human annotations. For example, in each iteration, human annotation is applied to a portion of the hard samples 232, which is approximately 4% of the given shard. The hard samples 232 can be hard annotations that the LLM 126a could not learn. Certain features are hard to learn or essentially cannot be learned by the LLM 126a. The system thus effectively corrects alignment errors made by the LLM 126a.

In short, during the reward model iterative alignment stage 204, the RLTHF detects plausible inaccuracies in LLM annotations across the new training dataset based on the reward distribution in the reward model, e.g., by identifying clusters of hard-to-annotate samples that are highly likely to be either mislabeled or correctly labeled by the LLM 126a. In each iteration, the RLTHF identifies and rectifies highly probable mislabeled data points using human annotations to provide human-annotated data. The RLTHF detects clusters of samples that are very likely to be correctly labeled by the LLM 126a, and incorporates them with the human-annotated data as a high-quality training dataset for the next iteration of the reward model training. Throughout this stage, RLTHF preserves data richness and maximizes the efficiency of human annotations through carefully controlled hyperparameters. RLTHF uses the reward model for ranking the samples and as a quality indicator for supervised fine-tuning. The reward model is iteratively trained to align the LLM's capability with SME preferences in data preparation as a bootstrapping point. In particular, the reward model is used to re-rank the data samples for measuring the alignment of the reward model with SME preferences. This indicates an automated metric to measure the data preparation progress that helps in monitoring the process without seeing actual data. The re-ranking of samples in the reward model can filter unconfident data from confident data that is sent for human annotations. Such iterative reward model training on confident data and targeted human-annotated data provides more precise alignment and better data coverage.

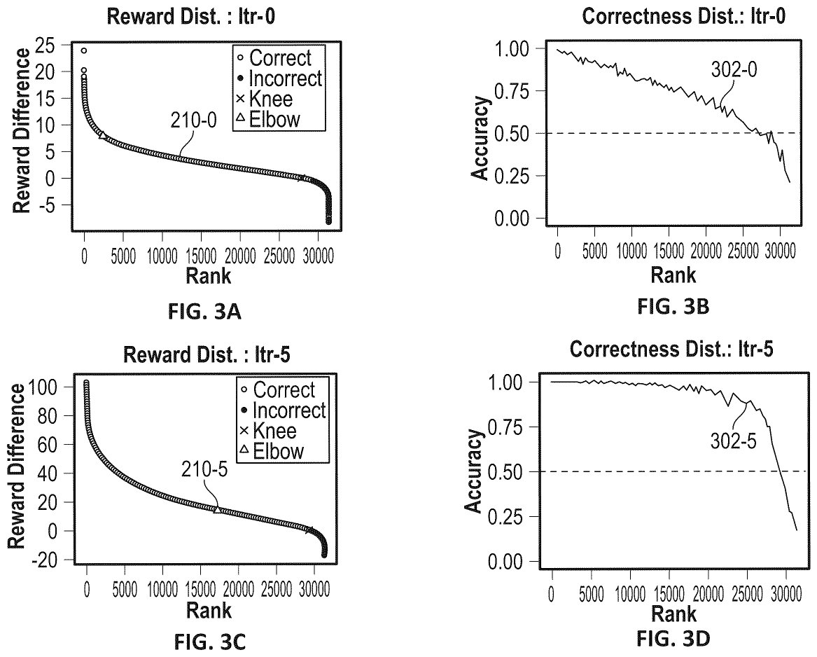

FIGS. 3A-3D are diagrams of reward distribution curves associated with training a reward model and correctness distribution curves with regard to full-human preference for the first and fifth/last iterations of RLTHF described herein. In FIGS. 3B and 3D, full human annotations/preferences Λh (e.g., full human annotations) for the initial and fifth/last iterations are depicted corresponding to the AI annotations ΛLLM depicted in FIGS. 3A and 3C. A reward density annotated by the LLM 126a is denoted as Λ(ΔΛLLM\hat{r}ΛLLM), and an accuracy density annotated by human is denoted as Λh for this experiment. Each preference pair or sample ρi∈ [symbol] ΛLLM is classified as either correctly or incorrectly labeled with regard to the full human preference Λh, i.e., whether the annotation/preference assigned by the LLM 126a ΛLLM matches Λh. As observed, the upper left region of the reward difference curve 210-0 in FIG. 3A contains a high density of correctly labeled samples, supporting that these represent the LLM's easy-to-annotate cases. To quantify this, an initial accuracy density curve 302-0 is generated for the reward difference curve 210-0 with regard to the full-human preference Λh, as shown in FIG. 3B.

In FIG. 3A, the sample with the highest reward difference of 24 is rank as #1, the sample with the second highest reward difference of 20 is rank as #2, and the like, and the reward difference decreases for samples further along a reward distribution curve 210-0 (i.e., an initial reward distribution curve, before any iteration), even turning into negative values like −9.

In FIG. 3B, the sample with the highest accuracy with regard to facts (e.g., winning sports teams) and/or human annotations/preferences of ~1 (i.e., 100%) is ranked as #1, the sample with the second highest accuracy of 0.99 (i.e., 99%) is ranked as #2, . . . , until into ~0.22 (i.e., 22%). FIG. 3B depicts sample alignment with facts and/or human annotations/preferences decreases as moving along a correctness distribution curve 302-0 (i.e., an initial correctness distribution curve, before any iteration). These two types of distribution curves depict the strategy of selecting hard-to-annotate samples for human annotations towards better alignment in the training dataset as follows.

The reward distribution curve ∂(ΔΛ\hat{r}Λ), derived from the training preference dataset [symbol] Λ, reflects the degree of alignment the reward model (trained with optimal validation loss) has achieved during training across [symbol] Λ. The upper left region of the curve consists of samples with high positive ΔΛ\hat{r}Λ, indicating strong agreement between the reward model and the training preference labels Λ. This suggests that the reward model effectively identifies and reinforces strong winning preference features in these samples, implying that these features were dominant in [symbol] Λ. In other words, the upper left region of the reward distribution curve 210-0 in FIG. 3A shows the rewards for the respective samples are highly aligning with the LLM annotator's preferences. The upper left region of the reward distribution curve 210-0 contains high density of correct LLM annotations, i.e., correct samples 224. A big score difference in positive (e.g., 15) means the LLM 126a is very confident in predicting the real winners and losers, since those samples were very easy for the LLM 126a to learn.

Conversely, the bottom right region of the reward distribution curve ∂(ΔΛ\hat{r}Λ) contains samples with very low or even negative ΔΛ\hat{r}Λ, signaling disagreement between the trained reward function \hat{r}Λ and the training preference label for these samples. This misalignment arises from two primary factors. (1) Absence of strong features, where the reward model is not able to find any strong preference feature in these samples according to \hat{r}Λ. (2) Conflicting samples within [symbol] Λ, where the preference features of these samples are highly conflicting with other stronger preference features learned in \hat{r}Λ, leading the reward model to penalize them. Since the LLM 126a was unable to correctly label these samples initially, the reward function \hat{r}ΛLLM cannot accurately capture their preference features. Consequently, these samples are expected to cluster around the bottom right region of the reward distribution curve ∂(ΔΛLLM\hat{r}ΛLLM). In short, the bottom right region of the reward distribution curve 210-0 contains high density of incorrect LLM annotations i.e., incorrect samples 226. The reasons for incorrect samples can be false positives (e.g., a predicted winning team did not win) made by the LLM annotator. For example, there were not enough matches data used to train the LLM 126a, i.e., an out of distribution issue.

The alignment of ΔΛLLM\hat{r}ΛLLM with Λh varies across the reward distribution curve 210-0. The system identifies two strategic points: the “elbow” and the “knee”, as illustrated in in FIG. 3A. These points correspond to sharp changes in ΔΛLLM\hat{r}ΛLLM, which are detected using the first-order derivative. The “knee” marks the transition to a region with lower accuracy density (e.g., a reward difference of less than 0, confident as incorrect), whereas the “elbow” indicates a shift toward higher accuracy density (e.g., a reward difference of more than 7, very confident as correct). As mentioned, these points serve as rough estimations of the region boundaries rather than precise demarcations. For example, the upper left region of the reward distribution curve 210-0 is defined as the section above the elbow, and the samples of the upper left region are directly included as the training data for the next training iteration of the reward model 208.

The bottom right region of the reward distribution curve 210-0 is defined as the section below the knee. Some samples in this region may exhibit preference features that are largely opposite to the dominant features captured by \hat{r}ΛLLM. These samples are highly likely to be mislabeled in ΛLLM. Instead of applying human annotations, the preferences of incorrect samples 226 of the bottom right region can be simply flipped into flipped samples 227 to correct the mislabeling in the flip step 230 (e.g., a winning team becoming a losing team). The flipped data is then included as a new training dataset (i.e., improved data 228, e.g., [{xti, yti,c, yti,r}], i=1, . . . , Nt) for the next training iteration of the reward model 208.

Optionally, the human-annotated data 236 is amplified in an amplify step 238, to increase their presence in the new training dataset by multiplying their data points (e.g., two or four times, called amplification ratio hyperparameter). Since there is a small number of human annotations in the first iteration, the system multiply the human-annotated data 236, before including them into the new training dataset.

The current reward function \hat{r}ΛLLM, trained on [symbol] ΛLLM, exhibits an alignment gap with respect to Λh due to the presence of hard-to-annotate samples for the LLM and mislabeling by the LLM 126a. The system refines [symbol] to improve alignment and trains the initial reward model at iteration 0 (Itr-0) with [symbol] ΛLLM and \hat{r}ΛLLM to better aligns with Λh using new training dataset (i.e., the improved data 228 better aligned with Λh). For the iteration 1 (Itr-1) training dataset,

$${𝒟}_{{Λ}_{Itr = 1}^{T}}^{T} ,$$

the improved data 228 includes human annotated samples from Itr-0, and he high-accuracy density region of ∂(ΔΛLLM\hat{r}ΛLLM), specifically the region to the left of the “elbow”. These two sets of samples offer high precision,

$${𝒟}_{{Λ}_{Itr = 1}^{T}}^{T}$$

yet face a data coverage issue. These two datasets represent samples with the longest feature distance, leaving gaps in intermediate regions. However, expanding the datasets by including samples from the middle region, i.e., right of the “elbow” and left of the “knee” risks introducing misaligned samples.

The middle region of the reward distribution curve 210-0 between the elbow and the knee in FIG. 3A is not so much aligning with the LLM annotator. Since the middle region of the reward distribution curve 210-0 in FIG. 3D contains both correct and incorrect samples, the system cannot simply flip the samples. For example, when 75% of the samples in the middle region were incorrect, flipping all samples causes 25% of the correct samples to become incorrect samples. As the accuracy in the middle region is likely to be just above 50%, obtaining human annotations for these samples would be inefficient. Furthermore, as the number of samples annotated from the right of the knee is relatively small, their preference features are likely to be overshadowed by the dominant preference features of the high numbers of left-side samples. As a result, their features may not be effectively captured in [symbol] To balance these trade-offs, the system introduces two hyperparameters specific to RLTHF, thereby providing a more controlled and effective dataset expansion while maintaining alignment quality.

Back-off ratio (β): Determines how far to back off from the “knee” when selecting samples for the next iteration's dataset. A higher β results in a more sanitized dataset, thereby reducing noise but at the expense of lower data coverage. The default β values are 60%, 60%, 60%, 40%, and 20% for iterations 1-5, respectively, and 10% for all subsequent iterations.

Amplification ratio (α): Increases the influence of human-annotated samples by repeating them in the dataset, thereby reinforcing their preference features in. [symbol] However, an excessively high α may lead to overfitting to selective human annotations. The default value of α is set to 4.

The dataset

$${𝒟}_{{Λ}_{Itr = 1}}^{T}$$

includes carefully selected samples from [symbol] ΛLLM, thereby ensuring high alignment with Λh by optimally tuning the hyperparameters α and β. Training the reward model on

$${𝒟}_{{Λ}_{Itr = 1}^{T}}^{T}$$

results in [symbol] which is more closely aligned with Λh. After training, the system constructs the new training dataset for generating the reward distribution curve by incorporating the remaining samples from Itr-0:

$${𝒟}_{{Λ}_{Itr - 1}} = {𝒟}_{{Λ}_{Itr - 1}^{T}}^{T} ⋃ ( {𝒟}_{{Λ}_{LLM}} - {𝒟}_{{Λ}_{Itr - 1}^{T}}^{T} ) ,$$

i.e., a new reward distribution curve,

$$ϑ ( {Δ}_{{Λ}_{Itr - 1}} \text{?} ) .$$

While this curve demonstrates improved alignment with Λh, full alignment is not yet achieved. However, it presents an improved reward distribution curve compared to the previous iteration. This evolving diversity in ∂(⋅) enhances the variety of human annotations, maximizing the return on annotation investments and incrementally enriching D. The effectiveness of this diversification, as well as the corresponding improvements, depend on factors such as hyperparameter tuning, the original data distribution, model selection, and the like. For example, larger amplification ratio (α) and back-off ratio (β) are beneficial in the initial iterations but the benefits gradually reduce as human annotations accumulate. These hyperparameters can be chosen based on heuristics and limited empirical observations, and the experiments are conducted with GPT-4o mini initial alignment to assess RLTHF's sensitivity to different factors.

As such, RLTHF progressively converges toward the full human annotations through iterative reward model training and strategic human annotation for hard samples. The reward/correctness distribution curves in FIGS. 3A-3D highlight the iterative refinement process, showing how the alignment in the training dataset is progressively improved. As shown in in FIGS. 3C-3D, after five iterations, a reward distribution curve 210-5 and a correctness distribution curve 302-5 closely align with the full-human annotations. In FIG. 3C, the sample rank #1 on the reward distribution curve 210-5 has a reward difference of 100 which is much higher than the sample rank #1 with a reward difference of 24 in FIG. 3D. The elbow in FIG. 3C ranks #17000 and has a reward difference of 18 which provides a much longer upper left region of the reward distribution curve 210-5 than the elbow rank #2400 with a reward difference of 7 in FIG. 3A. The longer the upper left region of the reward distribution curve, the more correct samples 224 to include in the improved data 228 for the next reward model iteration. The knee ranks 29000 in FIG. 3C and has a reward difference of 0 which provides a shorter bottom right region of the reward distribution curve 210-5 than the knee ranks 27500 with a reward difference of 1 in FIG. 3D. The shorter the bottom right region of the reward distribution curve, the fewer incorrect samples 226 to flip then include in the improved data 228 for the next reward model iteration. Apparently, the middle region of the reward distribution curve 210-5 is much shorter than the middle region of the reward distribution curve 210-0, so that few data points are sent for human annotations after the fifth iteration. The correctness distribution curve 302-5 shows significant improvement over the correctness distribution curve 302-0. The samples before the sample ranking 28000 has accuracy of 0.75+ (i.e., 75+%) in FIG. 3D, while samples before the sample ranking 15000 has accuracy of 0.75+ (i.e., 75+%) in FIG. 3B. The correctness distribution curve 302-5 have 13000 (i.e., 40% of the 32000 total samples) more samples with accuracy of 0.75+.

The actual number of iterations depends on the available human annotations and reward model training budget. Full-human alignment may be achieved before exhausting the annotation budget. In such cases, the samples selected for human annotations would largely lack distinct preference features, indicating that the reward model has effectively captured the human preferences. Once desired alignment is achieved or the annotation budget is fully utilized, RLTHF proceeds with fine-tuning the generative AI model for a downstream task, such as summarization.

In some scenarios, there is no knee and elbow in an initial reward distribution curve. For example, the initial reward distribution curve is close to a straight line, which signifies issues in training dataset. The dataset could be very dirty, or the LLM labeling was done as random labeling. The system can invite the user to fix the LLM prompt to do proper labeling, instead of random labeling.

Once desired alignment is achieved in a final iteration reward model (e.g., RM t+1), the knowledge transfer stage 206 can be performed via: 1) incorporating the final iteration reward model (e.g., RM t+1) into a PPO loop thereby optimizing the LLM 126a, or 2) labeling the whole dataset using the final iteration reward model (e.g., RM t+1) and feeding the labeled dataset to a DPO pipeline, thereby directly learning from preference data. The downstream task can be summarization, compliance, grounding, dialogue generation (e.g., enhancing chatbot interactions), code generation and completion (e.g., assisting with writing and debugging code), style transfer (e.g., adapting text to different tones or personas), personalized recommendations (e.g., creating customized content for users), data-to-text generation (e.g., converting structured data into natural language reports), medical and scientific text generation (e.g., producing clinical notes or research summaries), translation and multilingual adaptation (e.g., improving cross-lingual understanding), question answering (QA) (e.g., providing precise responses based on context), instruction following and task assistance (e.g., optimizing AI for automation and educational guidance), creative writing and content generation (e.g., generating poetry, scripts, or advertising copy), and the like.

To optimize the LLM 126a using PPO 244, the process follows the RLTHF where the LLM 126a acts as the policy being optimized, and applies the final iteration reward model (e.g., RM t+1) to evaluate the outputs of the LLM 126a. The PPO 244 updates the LLM 126a by iteratively adjusting the policy parameters to maximize the expected reward while ensuring stability through a clipped objective function that balances exploration (e.g., trying new responses) and exploitation (e.g., favoring known high-reward responses) to refine the policy iteratively.

During training, the LLM's responses are continuously evaluated by the final iteration reward model. The final iteration reward model guides the LLM's policy which defines how the LLM selects actions, thereby ensuring the LLM optimizes behavior that aligns with human values. The PPO 244 updates are applied to push the LLM 126a towards producing outputs that receive higher rewards. Regularization techniques, such as KL divergence penalties, are often used to prevent the updated policy from deviating too far from the original supervised model, maintaining linguistic fluency and coherence while improving alignment with human preferences. This iterative cycle ensures that the LLM 126a increasingly generates responses that better match human expectations over time. This technical solution balances performance improvement with training stability, while fine-tuning the LLM 126a into an aligned LLM 248 using minimum human annotations.

Taking the task of selecting winning sports teams among matches as an example, human annotators provide targeted feedback by ranking or selecting preferred team predictions of the false positives based on factors like past performance, player statistics, strategies, and the like. This feedback trains a reward model to approximate human judgment in predicting match outcomes. Then, policy optimization uses reinforcement learning algorithm PPO to adjust the prediction strategy of the LLM 126a to maximize the learned reward. Through iterative training, the LLM 126a refines its selection process, improving its ability to predict winning teams in a way that aligns with expert human decision-making, thus becomes the aligned LLM 248 for the winning sports team predicting task.

DPO is an alternative to traditional reinforcement learning approaches like PPO for aligning language models with human preferences. Instead of relying on an explicit reward model and reinforcement learning, DPO directly optimizes a language model policy using preference data. In an annotate step 240, the system annotates/labels the whole dataset using the final iteration reward model (e.g., RM t+1), and feeds the labeled/aligned data 242 into a DPO pipeline 246. The DPO pipeline 246 reformulates preference learning as a classification problem, where the LLM 126a learns to maximize the likelihood of preferred responses over dispreferred ones. By leveraging a simple loss function derived from a BT preference model, the DPO pipeline 246 enables stable and efficient fine-tuning the LLM 126a into the aligned LLM 248 without the complexities of reward modeling and reinforcement learning updates, thereby providing a more straightforward and scalable technical solution for aligning LLMs with minimum human annotations.

Taking the task of selecting social forum post summaries as example, the DPO pipeline 246 directly optimizes outputs of the LLM 126a based on human-labeled preferences. Instead of relying on reinforcement learning, DPO fine-tunes the LLM 126a using a contrastive loss function that encourages it to generate summaries preferred by humans while discouraging less-preferred ones. Human annotators rank different summaries, and the LLM 126a learns a scoring function that differentiates between high-quality and low-quality summaries. This technical solution simplifies alignment by avoiding complex reward modeling and policy optimization, making it more stable and efficient while ensuring that the LLM 126a produces summaries optimally capturing the essence of forum discussions according to human judgment.

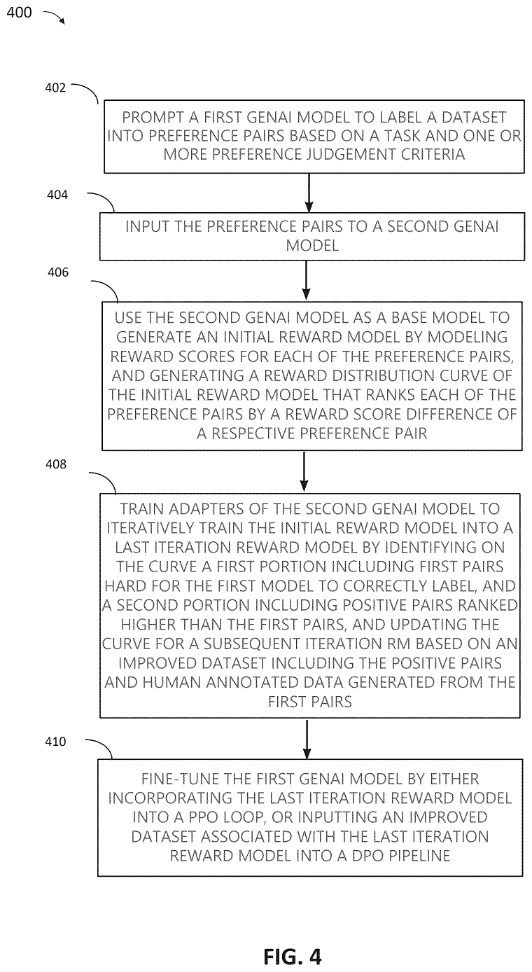

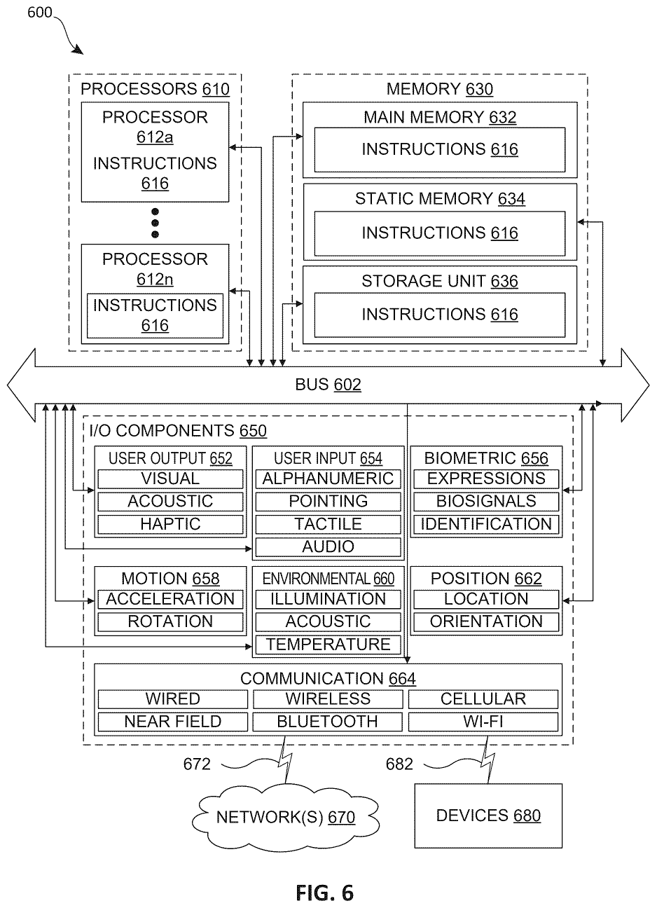

FIG. 4 is a flow chart of an example process 400 for AI model fine-tuning with a reward model iteratively trained on targeted human feedback according to the techniques disclosed herein. The process 400 can be implemented by the application services platform 110 or its components shown in the preceding examples. The process 400 may be implemented in, for instance, the example machine including a processor and a memory as shown in FIG. 6. As such, the application services platform 110 can provide means for accomplishing various parts of the process 400, as well as means for accomplishing embodiments of other processes described herein in conjunction with other components of the example computing environment 100. Although the process 400 is illustrated and described as a sequence of steps, it is contemplated that various embodiments of the process 400 may be performed in any order or combination and need not include all the illustrated steps.

In one embodiment, for example, in step 402, the AI model training unit 128 works in conjunction with the prompt construction unit 124 to prompt a first generative artificial intelligence (AI) model (e.g., the LLM 126a) to label an unlabeled dataset (e.g., the unannotated data 212) into a plurality of preference pairs (e.g., AI-annotated data 218) based on instructions of a task and one or more preference judgement criteria (e.g., clear, accurate, concise, and the like in Table 1). For instance, the task is summarization, compliance, grounding, dialogue generation, code generation and completion, style transfer, personalized recommendation, data-to-text generation, medical and scientific text generation, translation and multilingual adaptation, question answering, instruction following and task assistance, creative writing, or content generation. In step 404, the AI model training unit 128 inputs the preference pairs to a second generative AI model (e.g., Llama).

In step 406, the AI model training unit 128 works in conjunction with the prompt construction unit 124 to use the second generative AI model as a base model to generate an initial reward model (e.g., the initial reward model 208-0) by modeling reward scores for each of the preference pairs, and generating a reward distribution curve (e.g., the reward distribution curve 210) of the initial reward model that ranks each of the preference pairs by a reward score difference of a respective preference pair.

In step 408, the AI model training unit 128 works in conjunction with the prompt construction unit 124 to train adapters of the second generative AI model to iteratively train the initial reward model into a last iteration reward model (e.g., the fifth iteration reward model 208-5) by: automatically identifying a first portion (e.g., the upper left region 201a) and a second portion (e.g., the hard-to-annotated portion 210b) on the reward distribution curve (the first portion including first pairs (e.g., the hard samples 232) that are hard for the first generative AI model to correctly label, and the second portion includes positive pairs (e.g., the correct samples 224) ranked higher as compared to the first pairs), outputting the first pairs in the first portion for human annotations as annotated data (e.g., the human-annotated data 236), inputting the annotated data into an improved dataset (e.g., the improved data 228) including the positive pairs in the second portion, and updating the reward distribution curve for a subsequent iteration reward model (e.g., a first iteration reward model 208-1) based on the improved dataset.

In one implementation, the second generative AI model is prompted to determine an elbow (e.g., the elbow 210d) on a beginning potion of the reward distribution curve that has a positive reward difference of a first predetermined threshold (e.g., 7 in FIG. 3A), and the second pairs include preference pairs located on and above the elbow on the reward distribution curve. In addition, the second generative AI model is prompted to determine a knee (e.g., the knee 210e) on an end portion of the reward distribution curve that has a reward difference of a second predetermined threshold (e.g., 0 in FIG. 3A), and the first pairs include preference pairs located on and below the knee on the reward distribution curve.

In another implementation, the second generative AI model is prompted to determine a reflection point (e.g., the reflection point 210f in FIG. 2) of the reward distribution curve by reflecting the elbow (e.g., the elbow 210d in FIG. 2) across an x-axis on the end portion of the reward distribution curve; flip preferences for preference pairs in a flipping region (e.g., the flipping region 210c in FIG. 2) between the reflection point and an end of the reward distribution curve as flipped data (e.g., the flipped samples 227); and include the flipped data in the improved dataset. The reward distribution curve is updated based on the improved dataset that further includes the flipped data.

In yet another implementation, the second generative AI model is prompted to select a random portion (e.g., down-sampling ¼ shard into the N samples 216 in FIG. 2) of the unlabeled dataset as a sampled dataset, and the preference pairs for generating the reward distribution curve of the reward model are the sampled dataset labelled based on the instructions.

In yet another implementation, the second generative AI model is prompted to multiply the annotated data (e.g., the human-annotated data 236) as amplified annotated data; and includes the amplified annotated data in the improved data. The reward distribution curve is updated based on the improved dataset that includes the amplified annotated data.

In yet another implementation, the second generative AI model is prompted to select a preference dataset from the second pairs (e.g., the correct samples 224) for human annotations; and validate the initial reward model 208-0 when the preference datasets agree with the human annotations meeting a threshold, before iteratively training the initial reward model.

In step 410, the AI model training unit 128 fine-tunes the first generative AI model by either incorporating the last iteration reward model 208-5 into a PPO loop (e.g., the PPO 244), or inputting an improved dataset associated with the last iteration reward model 208-5 into a DPO pipeline (e.g., the DPO 246). For example, incorporating the last iteration reward model into the PPO loop includes: generating a set of preference pairs using the first generative AI model (e.g., the LLM 126a); ranking the set preference pairs based on the last iteration reward model 208-5; and running the PPO loop to iteratively update a policy of the first generative AI model to maximize cumulative rewards. As another example, inputting the improved dataset associated with the last iteration reward model 208-5 into the DPO pipeline includes optimizing a policy of the first generative AI model by minimizing a binary classification loss between preferred and non-preferred responses in a respective preference pair in the improved dataset.

RLTHF, an iterative reward model training approach, enhances alignment in preference datasets by strategically infusing human annotations, complemented by sanitized AI labeling. Through reward distribution analysis, key samples are identified for targeted human intervention, thereby optimizing annotation efficiency. RLTHF progressively improves alignment, converging toward comprehensive human alignment. Furthermore, models trained on the refined datasets for downstream tasks even outperform the models trained on datasets with full-human annotations. RLTHF reaches full-human annotation-level alignment with only 6-7% of the human annotation effort. Furthermore, AI models trained on RLTHF's curated datasets for downstream tasks outperform those trained on fully human-annotated datasets, underscoring the effectiveness of RLTHF's strategic data curation.

All the above-discussed raw data 140 (e.g., the unannotated data 212, and the N samples 216), AI-annotated data 142 (e.g., the AI-annotated data 218), reward and correctness distribution curve data 144 (e.g., data of the reward distribution curves 210-0, . . . 210-5, and data of the correctness distribution curves 302-0, . . . 302-5), training data 146 (e.g., the correct samples 224, the incorrect samples 226, the flipped samples 227, the hard samples 232, the improved data 228, and the aligned data 242), and requests, prompts and responses 148 (e.g., the requests, prompts and responses associated with the LLM 126a) can be stored in an enterprise data storage 134. The enterprise data storage 134 can be physical and/or virtual, depending on the entity's needs and IT infrastructure. Examples of physical enterprise data storage systems include network-attached storage (NAS), storage area network (SAN), direct-attached storage (DAS), tape libraries, hybrid storage arrays, object storage, and the like. Examples of virtual enterprise data storage systems include virtual SAN (vSAN), software-defined storage (SDS), cloud storage, hyper-converged Infrastructure (HCl), network virtualization and software-defined networking (SDN), container storage, and the like.

There are security and privacy considerations and strategies for using open source generative models with enterprise data, such as data anonymization, isolating data, providing secure access, securing the model, using a secure environment, encryption, regular auditing, compliance with laws and regulations, data retention policies, performing privacy impact assessment, user education, performing regular updates, providing disaster recovery and backup, providing an incident response plan, third-party reviews, and the like. By following these security and privacy best practices, the example computing environment 100 can minimize the risks associated with using open source generative models while protecting enterprise data from unauthorized access or exposure.

In an example, the application services platform 110 can store enterprise data separately from generative model training data, to reduce the risk of unintentionally leaking sensitive information during model generation. The application services platform 110 can limit access to generative models and the enterprise data. The application services platform 110 can also implement proper access controls, strong authentication, and authorization mechanisms to ensure that only authorized personnel can interact with the selected model and the enterprise data.

The application services platform 110 can also run the AI model 126 in a secure computing environment. Moreover, the application services platform 110 can employ robust network security, firewalls, and intrusion detection systems to protect against external threats. The application services platform 110 can encrypt the enterprise data and any data in transit. The application services platform 110 can also employ encryption standards for data storage and data transmission to safeguard against data breaches.

Moreover, the application services platform 110 can implement strong security measures around the AI model 126 itself, such as regular security audits, code reviews, and ensuring that the model is up-to-date with security patches. The application services platform 110 can periodically audit the generative model's usage and access logs, to detect any unauthorized or anomalous activities. The application services platform 110 can also ensure that any use of open source generative models complies with relevant data protection regulations such as GDPR, HIPAA, or other industry-specific compliance standards.

The application services platform 110 can establish data retention and data deletion policies to ensure that generated data is not stored longer than necessary, to minimizes the risk of data exposure. The application services platform 110 can perform a privacy impact assessment (PIA) to identify and mitigate potential privacy risks associated with the generative model's usage. The application services platform 110 can also provide mechanisms for training and educating users on the proper handling of enterprise data and the responsible use of generative models. In addition, the application services platform 110 can stay up-to-date with evolving security threats and best practices that are essential for ongoing data protection.

In some implementations, the system provides a feedback loop by augmenting thumbs up and thumbs down buttons for each scheduled item in a user interface of the client device 105. If the user dislikes a task event item, the system can ask why and use the input to improve the summarized content item. A thumbs down click could also prompt the user to indicate whether the event item was scheduled for too long, too short, or was assigned the wrong time slot.

In some implementations, the application services platform 110 includes moderation services that analyze user prompt(s), user feedback, and responses generated by the AI models 126, to ensure that potentially objectionable or offensive content is not generated or utilized by the application services platform 110. If potentially objectionable or offensive content is detected in the user prompt(s), the user feedback, and the responses, the moderation services provide a blocked content notification to the client device 105 indicating that the prompt(s), the user data is blocked from forming the system prompt. In some implementations, the request processing unit 122 discards any user query that includes potentially objectionable or offensive content and passes any remaining content that has not been discarded to the request processing unit 122 to be provided as an input to the prompt construction unit 124. In other implementations, the prompt construction unit 124 discards any content that includes potentially objectionable or offensive content and passes any remaining content that has not been discarded to the AI models 126 as an input.

As discussed, the moderation services generate a blocked content notification in response to determining that the user queries, and/or the system prompt includes potentially objectionable or offensive content, and the notification is provided to the native application 114 or the browser application 112 so that the notification can be presented to the user on the client device 105. For instance, the user may attempt to revise and resubmit the user queries. As another example, the system may generate another system prompt after removing task data associated with the potentially objectionable or offensive content. The moderation services can be implemented by a machine learning model trained to analyze the content of these various inputs and/or outputs to perform a semantic analysis on the content to predict whether the content includes potentially objectionable or offensive content (e.g., language/image/sound).

The entity database 132 includes human annotator profile data (e.g., of subject matter experts (SMEs) 132a). The human annotator profile data includes basic identifiers (e.g., anonymized IDs and demographic details), skills and qualifications (e.g., domain expertise and language proficiency), annotation performance metrics (e.g., accuracy scores, inter-annotator agreement, and error rates), work history and engagement (e.g., tasks completed, categories worked on, and review history), behavioral reliability (e.g., consistency, flagged submissions, and time spent per task), compensation details (e.g., pay rate and employment type), and the like. The entity database 132 can be implemented on the application services platform 110 in some implementations. In other implementations, at least a portion of the entity database 132 are implemented on an external server that is accessible by the AI model training unit 128.

As mentioned, the application services platform 110 complies with privacy guidelines and regulations that apply to the usage of user data included in the entity database 132 to ensure that users have control over how the application services platform 110 utilizes their data. The user is provided with an opportunity to opt into the application services platform 110 to allow the application services platform 110 to access the user data. In some implementations, the first time that an application, such as the native application 114 or the browser application 112 presents the data analysis assistant to the user, the user is presented with a message that indicates that the user may opt into allowing the application services platform 110 to access user data included in the entity database 132 to support the AI model fine-tuning functionality. The user may opt into allowing the application services platform 110 to access all or a subset of user data included in the entity database 132. Furthermore, the user may modify their opt-in status at any time by accessing their user data and selectively opting into or opting out of allowing the application services platform 110 from accessing and utilizing user data from the entity database 132 as a whole or individually.

Therefore, the system can assist users to fine-tune generative models for different tasks with more accurate and relevant results for targeted tasks as well as reduced cost. The RLTHF simplifies DNO thus reduces the resources needed for fine-tuning, saving time and computational expenses.

The RLTHF can be applied to fine-tune any generative models tailed for different tasks in various applications (e.g., email applications, calendar applications, task management applications, software development applications, and the like) to generate a summarized content item, via a chat interface. Such interactive, chat-based resource allocation assistance can help a user to generate the summarized content item comprehensively, quickly and accurately.

In addition, the system provides users with interactive tools to refine the summarized content item, and infer actions to complete tasks in the summarized content item. For example, the system uses generative AI to create a summarized content item for a surgical center. Each task event is assigned with a discrete timeslot, inferred resources, resource consuming entities, and the like that provide context and relevant information to perform the task event. A user can use the AI-assisted resource allocation application at the start of a day and view a summarized content item with task events and suggested actions to complete each task event.

The detailed examples of systems, devices, and techniques described in connection with FIGS. 1-4 are presented herein for illustration of the disclosure and its benefits. Such examples of use should not be construed to be limitations on the logical process embodiments of the disclosure, nor should variations of user interface methods from those described herein be considered outside the scope of the present disclosure. It is understood that references to displaying or presenting an item (such as, but not limited to, presenting an image on a display device, presenting audio via one or more loudspeakers, and/or vibrating a device) include issuing instructions, commands, and/or signals causing, or reasonably expected to cause, a device or system to display or present the item. In some embodiments, various features described in FIGS. 1-4 are implemented in respective modules, which may also be referred to as, and/or include, logic, components, units, and/or mechanisms. Modules may constitute either software modules (for example, code embodied on a machine-readable medium) or hardware modules.

In some examples, a hardware module may be implemented mechanically, electronically, or with any suitable combination thereof. For example, a hardware module may include dedicated circuitry or logic that is configured to perform certain operations. For example, a hardware module may include a special-purpose processor, such as a field-programmable gate array (FPGA) or an Application Specific Integrated Circuit (ASIC). A hardware module may also include programmable logic or circuitry that is temporarily configured by software to perform certain operations and may include a portion of machine-readable medium data and/or instructions for such configuration. For example, a hardware module may include software encompassed within a programmable processor configured to execute a set of software instructions. It will be appreciated that the decision to implement a hardware module mechanically, in dedicated and permanently configured circuitry, or in temporarily configured circuitry (for example, configured by software) may be driven by cost, time, support, and engineering considerations.

Accordingly, the phrase “hardware module” should be understood to encompass a tangible entity capable of performing certain operations and may be configured or arranged in a certain physical manner, be that an entity that is physically constructed, permanently configured (for example, hardwired), and/or temporarily configured (for example, programmed) to operate in a certain manner or to perform certain operations described herein. As used herein, “hardware-implemented module” refers to a hardware module. Considering examples in which hardware modules are temporarily configured (for example, programmed), each of the hardware modules need not be configured or instantiated at any one instance in time. For example, where a hardware module includes a programmable processor configured by software to become a special-purpose processor, the programmable processor may be configured as respectively different special-purpose processors (for example, including different hardware modules) at different times. Software may accordingly configure a processor or processors, for example, to constitute a particular hardware module at one instance of time and to constitute a different hardware module at a different instance of time. A hardware module implemented using one or more processors may be referred to as being “processor implemented” or “computer implemented.”

Hardware modules can provide information to, and receive information from, other hardware modules. Accordingly, the described hardware modules may be regarded as being communicatively coupled. Where multiple hardware modules exist contemporaneously, communications may be achieved through signal transmission (for example, over appropriate circuits and buses) between or among two or more of the hardware modules. In embodiments in which multiple hardware modules are configured or instantiated at different times, communications between such hardware modules may be achieved, for example, through the storage and retrieval of information in memory devices to which the multiple hardware modules have access. For example, one hardware module may perform an operation and store the output in a memory device, and another hardware module may then access the memory device to retrieve and process the stored output.

In some examples, at least some of the operations of a method may be performed by one or more processors or processor-implemented modules. Moreover, the one or more processors may also operate to support performance of the relevant operations in a “cloud computing” environment or as a “software as a service” (SaaS). For example, at least some of the operations may be performed by, and/or among, multiple computers (as examples of machines including processors), with these operations being accessible via a network (for example, the Internet) and/or via one or more software interfaces (for example, an application program interface (API)). The performance of certain of the operations may be distributed among the processors, not only residing within a single machine, but deployed across several machines. Processors or processor-implemented modules may be in a single geographic location (for example, within a home or office environment, or a server farm), or may be distributed across multiple geographic locations.

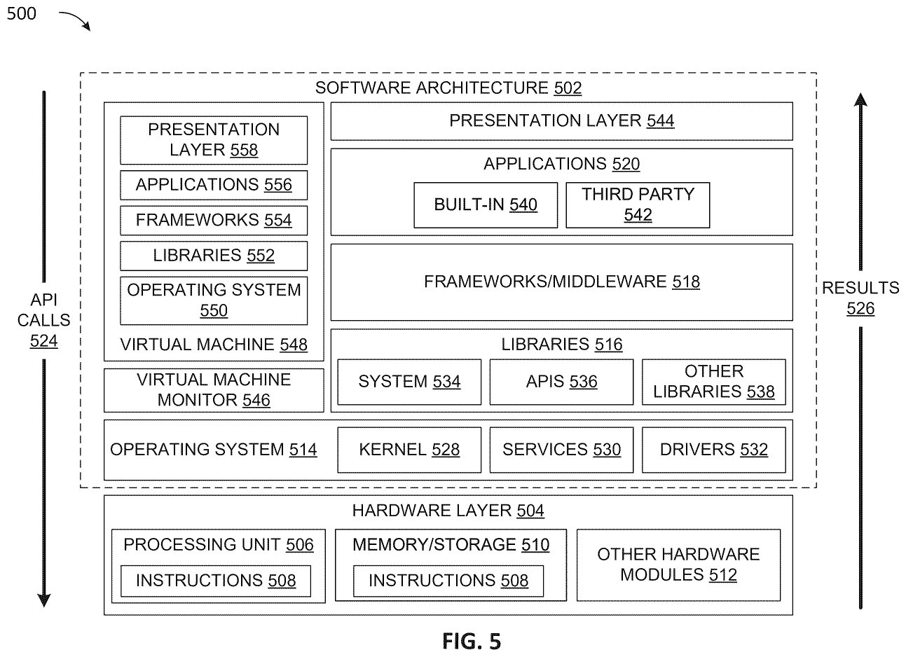

FIG. 5 is a block diagram 500 illustrating an example software architecture 502, various portions of which may be used in conjunction with various hardware architectures herein described, which may implement any of the above-described features. FIG. 5 is a non-limiting example of a software architecture, and it will be appreciated that many other architectures may be implemented to facilitate the functionality described herein. The software architecture 502 may execute on hardware such as a machine 600 of FIG. 6 that includes, among other things, processors 610, memory 630, and input/output (I/O) components 650. A representative hardware layer 504 is illustrated and can represent, for example, the machine 600 of FIG. 6. The representative hardware layer 504 includes a processing unit 506 and associated executable instructions 508. The executable instructions 508 represent executable instructions of the software architecture 502, including implementation of the methods, modules and so forth described herein. The hardware layer 504 also includes a memory/storage 510, which also includes the executable instructions 508 and accompanying data. The hardware layer 504 may also include other hardware modules 512. The executable instructions 508 held by processing unit 506 may be portions of the executable instructions 508 held by the memory/storage 510.

The example software architecture 502 may be conceptualized as layers, each providing various functionality. For example, the software architecture 502 may include layers and components such as an operating system (OS) 514, libraries 516, frameworks/middleware 518, applications 520, and a presentation layer 544. Operationally, the applications 520 and/or other components within the layers may invoke API calls 524 to other layers and receive corresponding results 526. The layers illustrated are representative in nature and other software architectures may include additional or different layers. For example, some mobile or special purpose operating systems may not provide the frameworks/middleware 518.

The OS 514 may manage hardware resources and provide common services. The OS 514 may include, for example, a kernel 528, services 530, and drivers 532. The kernel 528 may act as an abstraction layer between the hardware layer 504 and other software layers. For example, the kernel 528 may be responsible for memory management, processor management (for example, scheduling), component management, networking, security settings, and so on. The services 530 may provide other common services for the other software layers. The drivers 532 may be responsible for controlling or interfacing with the underlying hardware layer 504. For instance, the drivers 532 may include display drivers, camera drivers, memory/storage drivers, peripheral device drivers (for example, via Universal Serial Bus (USB)), network and/or wireless communication drivers, audio drivers, and so forth depending on the hardware and/or software configuration.

The libraries 516 may provide a common infrastructure that may be used by the applications 520 and/or other components and/or layers. The libraries 516 typically provide functionality for use by other software modules to perform tasks, rather than interacting directly with the OS 514. The libraries 516 may include system libraries 534 (for example, C standard library) that may provide functions such as memory allocation, string manipulation, file operations. In addition, the libraries 516 may include API libraries 536 such as media libraries (for example, supporting presentation and manipulation of image, sound, and/or video data formats), graphics libraries (for example, an OpenGL library for rendering 2D and 3D graphics on a display), database libraries (for example, SQLite or other relational database functions), and web libraries (for example, WebKit that may provide web browsing functionality). The libraries 516 may also include a wide variety of other libraries 538 to provide many functions for applications 520 and other software modules.

The frameworks/middleware 518 (also sometimes referred to as middleware) provide a higher-level common infrastructure that may be used by the applications 520 and/or other software modules. For example, the frameworks/middleware 518 may provide various graphic user interface (GUI) functions, high-level resource management, or high-level location services. The frameworks/middleware 518 may provide a broad spectrum of other APIs for applications 520 and/or other software modules.

The applications 520 include built-in applications 540 and/or third-party applications 542. Examples of built-in applications 540 may include, but are not limited to, a contacts application, a browser application, a location application, a media application, a messaging application, and/or a game application. Third-party applications 542 may include any applications developed by an entity other than the vendor of the particular platform. The applications 520 may use functions available via OS 514, libraries 516, frameworks/middleware 518, and presentation layer 544 to create user interfaces to interact with users.

Some software architectures use virtual machines, as illustrated by a virtual machine 548. The virtual machine 548 provides an execution environment where applications/modules can execute as if they were executing on a hardware machine (such as the machine 600 of FIG. 6, for example). The virtual machine 548 may be hosted by a host OS (for example, OS 514) or hypervisor, and may have a virtual machine monitor 546 which manages operation of the virtual machine 548 and interoperation with the host operating system. A software architecture, which may be different from software architecture 502 outside of the virtual machine, executes within the virtual machine 548 such as an OS 550, libraries 552, frameworks 554, applications 556, and/or a presentation layer 558.

FIG. 6 is a block diagram illustrating components of an example machine 600 configured to read instructions from a machine-readable medium (for example, a machine-readable storage medium) and perform any of the features described herein. The example machine 600 is in a form of a computer system, within which instructions 616 (for example, in the form of software components) for causing the machine 600 to perform any of the features described herein may be executed. As such, the instructions 616 may be used to implement modules or components described herein. The instructions 616 cause unprogrammed and/or unconfigured machine 600 to operate as a particular machine configured to carry out the described features. The machine 600 may be configured to operate as a standalone device or may be coupled (for example, networked) to other machines. In a networked deployment, the machine 600 may operate in the capacity of a server machine or a client machine in a server-client network environment, or as a node in a peer-to-peer or distributed network environment. Machine 600 may be embodied as, for example, a server computer, a client computer, a personal computer (PC), a tablet computer, a laptop computer, a netbook, a set-top box (STB), a gaming and/or entertainment system, a smart phone, a mobile device, a wearable device (for example, a smart watch), and an Internet of Things (IoT) device. Further, although only a single machine 600 is illustrated, the term “machine” includes a collection of machines that individually or jointly execute the instructions 616.

The machine 600 may include processors 610, memory 630, and I/O components 650, which may be communicatively coupled via, for example, a bus 602. The bus 602 may include multiple buses coupling various elements of machine 600 via various bus technologies and protocols. In an example, the processors 610 (including, for example, a central processing unit (CPU), a graphics processing unit (GPU), a neural processing unit (NPU), a tensor processing unit (TPU), a digital signal processor (DSP), an ASIC, or a suitable combination thereof) may include one or more processors 612a to 612n that may execute the instructions 616 and process data. In some examples, one or more processors 610 may execute instructions provided or identified by one or more other processors 610. The term “processor” includes a multi-core processor including cores that may execute instructions contemporaneously. Although FIG. 6 shows multiple processors, the machine 600 may include a single processor with a single core, a single processor with multiple cores (for example, a multi-core processor), multiple processors each with a single core, multiple processors each with multiple cores, or any combination thereof. In some examples, the machine 600 may include multiple processors distributed among multiple machines.

The memory 630 may include a main memory 632, a static memory 634, or other memory, and a storage unit 636, both accessible to the processors 610 such as via the bus 602. The storage unit 636 and memory 632, 634 store instructions 616 embodying any one or more of the functions described herein. The memory 630 may also store temporary, intermediate, and/or long-term data for processors 610. The instructions 616 may also reside, completely or partially, within the memory 632, 634, within the storage unit 636, within at least one of the processors 610 (for example, within a command buffer or cache memory), within memory at least one of I/O components 650, or any suitable combination thereof, during execution thereof. Accordingly, the memory 632, 634, the storage unit 636, memory in processors 610, and memory in I/O components 650 are examples of machine-readable media.

As used herein, “machine-readable medium” refers to a device able to temporarily or permanently store instructions and data that cause machine 600 to operate in a specific fashion, and may include, but is not limited to, random-access memory (RAM), read-only memory (ROM), buffer memory, flash memory, optical storage media, magnetic storage media and devices, cache memory, network-accessible or cloud storage, other types of storage and/or any suitable combination thereof. The term “machine-readable medium” applies to a single medium, or combination of multiple media, used to store instructions (for example, instructions 616) for execution by a machine 600 such that the instructions, when executed by one or more processors 610 of the machine 600, cause the machine 600 to perform and one or more of the features described herein. Accordingly, a “machine-readable medium” may refer to a single storage device, as well as “cloud-based” storage systems or storage networks that include multiple storage apparatus or devices. The term “machine-readable medium” excludes signals per se.

The I/O components 650 may include a wide variety of hardware components adapted to receive input, provide output, produce output, transmit information, exchange information, capture measurements, and so on. The specific I/O components 650 included in a particular machine will depend on the type and/or function of the machine. For example, mobile devices such as mobile phones may include a touch input device, whereas a headless server or IoT device may not include such a touch input device. The particular examples of I/O components illustrated in FIG. 6 are in no way limiting, and other types of components may be included in machine 600. The grouping of I/O components 650 are merely for simplifying this discussion, and the grouping is in no way limiting. In various examples, the I/O components 650 may include user output components 652 and user input components 654. User output components 652 may include, for example, display components for displaying information (for example, a liquid crystal display (LCD) or a projector), acoustic components (for example, speakers), haptic components (for example, a vibratory motor or force-feedback device), and/or other signal generators. User input components 654 may include, for example, alphanumeric input components (for example, a keyboard or a touch screen), pointing components (for example, a mouse device, a touchpad, or another pointing instrument), and/or tactile input components (for example, a physical button or a touch screen that provides location and/or force of touches or touch gestures) configured for receiving various user inputs, such as user commands and/or selections.

In some examples, the I/O components 650 may include biometric components 656, motion components 658, environmental components 660, and/or position components 662, among a wide array of other physical sensor components. The biometric components 656 may include, for example, components to detect body expressions (for example, facial expressions, vocal expressions, hand or body gestures, or eye tracking), measure biosignals (for example, heart rate or brain waves), and identify a person (for example, via voice-, retina-, fingerprint-, and/or facial-based identification). The motion components 658 may include, for example, acceleration sensors (for example, an accelerometer) and rotation sensors (for example, a gyroscope). The environmental components 660 may include, for example, illumination sensors, temperature sensors, humidity sensors, pressure sensors (for example, a barometer), acoustic sensors (for example, a microphone used to detect ambient noise), proximity sensors (for example, infrared sensing of nearby objects), and/or other components that may provide indications, measurements, or signals corresponding to a surrounding physical environment. The position components 662 may include, for example, location sensors (for example, a Global Position System (GPS) receiver), altitude sensors (for example, an air pressure sensor from which altitude may be derived), and/or orientation sensors (for example, magnetometers).

The I/O components 650 may include communication components 664, implementing a wide variety of technologies operable to couple the machine 600 to network(s) 670 and/or device(s) 680 via respective communicative couplings 672 and 682. The communication components 664 may include one or more network interface components or other suitable devices to interface with the network(s) 670. The communication components 664 may include, for example, components adapted to provide wired communication, wireless communication, cellular communication, Near Field Communication (NFC), Bluetooth communication, Wi-Fi, and/or communication via other modalities. The device(s) 680 may include other machines or various peripheral devices (for example, coupled via USB).

In some examples, the communication components 664 may detect identifiers or include components adapted to detect identifiers. For example, the communication components 664 may include Radio Frequency Identification (RFID) tag readers, NFC detectors, optical sensors (for example, one- or multi-dimensional bar codes, or other optical codes), and/or acoustic detectors (for example, microphones to identify tagged audio signals). In some examples, location information may be determined based on information from the communication components 664, such as, but not limited to, geo-location via Internet Protocol (IP) address, location via Wi-Fi, cellular, NFC, Bluetooth, or other wireless station identification and/or signal triangulation.

In the preceding detailed description, numerous specific details are set forth by way of examples in order to provide a thorough understanding of the relevant teachings. However, it should be apparent that the present teachings may be practiced without such details. In other instances, well known methods, procedures, components, and/or circuitry have been described at a relatively high-level, without detail, in order to avoid unnecessarily obscuring aspects of the present teachings.

While various implementations have been described, the description is intended to be exemplary, rather than limiting, and it is understood that many more implementations and implementations are possible that are within the scope of the implementations. Although many possible combinations of features are shown in the accompanying figures and discussed in this detailed description, many other combinations of the disclosed features are possible. Any feature of any implementation may be used in combination with or substituted for any other feature or element in any other implementation unless specifically restricted. Therefore, it will be understood that any of the features shown and/or discussed in the present disclosure may be implemented together in any suitable combination. Accordingly, the implementations are not to be restricted except in light of the attached claims and their equivalents. Also, various modifications and changes may be made within the scope of the attached claims.

While the foregoing has described what are considered to be the best mode and/or other examples, it is understood that various modifications may be made therein and that the subject matter disclosed herein may be implemented in various forms and examples, and that the teachings may be applied in numerous applications, only some of which have been described herein. It is intended by the following claims to claim any and all applications, modifications and variations that fall within the true scope of the present teachings.

Unless otherwise stated, all measurements, values, ratings, positions, magnitudes, sizes, and other specifications that are set forth in this specification, including in the claims that follow, are approximate, not exact. They are intended to have a reasonable range that is consistent with the functions to which they relate and with what is customary in the art to which they pertain.

The scope of protection is limited solely by the claims that now follow. That scope is intended and should be interpreted to be as broad as is consistent with the ordinary meaning of the language that is used in the claims when interpreted in light of this specification and the prosecution history that follows and to encompass all structural and functional equivalents. Notwithstanding, none of the claims are intended to embrace subject matter that fails to satisfy the requirement of Sections 101, 102, or 103 of the Patent Act, nor should they be interpreted in such a way. Any unintended embracement of such subject matter is hereby disclaimed.

Except as stated immediately above, nothing that has been stated or illustrated is intended or should be interpreted to cause a dedication of any component, step, feature, object, benefit, advantage, or equivalent to the public, regardless of whether it is or is not recited in the claims.

It will be understood that the terms and expressions used herein have the ordinary meaning as is accorded to such terms and expressions with respect to their corresponding respective areas of inquiry and study except where specific meanings have otherwise been set forth herein. Relational terms such as first and second and the like may be used solely to distinguish one entity or action from another without necessarily requiring or implying any actual such relationship or order between such entities or actions. The terms “comprises,” “comprising,” or any other variation thereof, are intended to cover a non-exclusive inclusion, such that a process, method, article, or apparatus that comprises a list of elements does not include only those elements but may include other elements not expressly listed or inherent to such process, method, article, or apparatus. An element proceeded by “a” or “an” does not, without further constraints, preclude the existence of additional identical elements in the process, method, article, or apparatus that comprises the element. Furthermore, subsequent limitations referring back to “said element” or “the element” performing certain functions signifies that “said element” or “the element” alone or in combination with additional identical elements in the process, method, article, or apparatus are capable of performing all of the recited functions.

The Abstract of the Disclosure is provided to allow the reader to quickly ascertain the nature of the technical disclosure. It is submitted with the understanding that it will not be used to interpret or limit the scope or meaning of the claims. In addition, in the foregoing Detailed Description, it can be seen that various features are grouped together in various examples for the purpose of streamlining the disclosure. This method of disclosure is not to be interpreted as reflecting an intention that the claims require more features than are expressly recited in each claim. Rather, as the following claims reflect, inventive subject matter lies in less than all features of a single disclosed example. Thus, the following claims are hereby incorporated into the Detailed Description, with each claim standing on its own as a separately claimed subject matter.

What is claimed is:

1. A data processing system comprising:
a processor, and
a machine-readable storage medium storing executable instructions which, when executed by the processor, cause the processor alone or in combination with other processors to perform following operations:
prompting a first generative artificial intelligence (AI) model to label an unlabeled dataset into a plurality of preference pairs based on instructions of a task and one or more preference judgement criteria;
inputting the preference pairs to a second generative AI model;
using the second generative AI model as a base model to generate an initial reward model by modeling reward scores for each of the preference pairs, and generating a reward distribution curve of the initial reward model that ranks each of the preference pairs by a reward score difference of a respective preference pair;
training adapters of the second generative AI model to iteratively train the initial reward model into a last iteration reward model by:
automatically identifying a first portion and a second portion on the reward distribution curve, wherein the first portion includes first pairs that are hard for the first generative AI model to correctly label, and the second portion includes positive pairs ranked higher as compared to the first pairs,
outputting the first pairs in the first portion for human annotations as annotated data,
inputting the annotated data into an improved dataset including the positive pairs in the second portion, and
updating the reward distribution curve for a subsequent iteration reward model based on the improved dataset; and
fine-tuning the first generative AI model by either incorporating the last iteration reward model into a proximal policy optimization (PPO) loop, or inputting an improved dataset associated with the last iteration reward model into a direct preference optimization (DPO) pipeline.

2. The data processing system of claim 1, wherein the machine-readable storage medium further includes instructions configured to cause the processor alone or in combination with other processors to perform:
determining an elbow on a beginning potion of the reward distribution curve that has a positive reward difference of a first predetermined threshold, wherein the second pairs include preference pairs located on and above the elbow on the reward distribution curve.

3. The data processing system of claim 2, wherein the machine-readable storage medium further includes instructions configured to cause the processor alone or in combination with other processors to perform:
determining a knee on an end portion of the reward distribution curve that has a reward difference of a second predetermined threshold, wherein the first pairs include preference pairs located on and below the knee on the reward distribution curve.

4. The data processing system of claim 3, wherein the machine-readable storage medium further includes instructions configured to cause the processor alone or in combination with other processors to perform:
determining a reflection point of the reward distribution curve by reflecting the elbow across an x-axis on the end portion of the reward distribution curve;
flipping preferences for preference pairs in a flipping region between the reflection point and an end of the reward distribution curve as flipped data; and
including the flipped data in the improved dataset, wherein the reward distribution curve is updated based on the improved dataset that further includes the flipped data.

5. The data processing system of claim 1, wherein the machine-readable storage medium further includes instructions configured to cause the processor alone or in combination with other processors to perform:
selecting a random portion of the unlabeled dataset as a sampled dataset,
wherein the preference pairs for generating the reward distribution curve of the reward model are the sampled dataset labelled based on the instructions.

6. The data processing system of claim 1, wherein incorporating the last iteration reward model into the PPO loop includes:
generating a set of preference pairs using the first generative AI model;
ranking the set preference pairs based on the last iteration reward model; and
running the PPO loop to iteratively update a policy of the first generative AI model to maximize cumulative rewards.

7. The data processing system of claim 1, wherein inputting the improved dataset associated with the last iteration reward model into the DPO pipeline includes optimizing a policy of the first generative AI model by minimizing a binary classification loss between preferred and non-preferred responses in a respective preference pair in the improved dataset.

8. The data processing system of claim 1, wherein the machine-readable storage medium further includes instructions configured to cause the processor alone or in combination with other processors to perform:
multiplying the annotated data as amplified annotated data; and
including the amplified annotated data in the improved data, wherein the reward distribution curve is updated based on the improved dataset that includes the amplified annotated data.

9. The data processing system of claim 1, wherein the machine-readable storage medium further includes instructions configured to cause the processor alone or in combination with other processors to perform:
selecting a preference dataset from the second pairs for human annotations; and
validating the initial reward model when the preference datasets agree with the human annotations meeting a threshold, before iteratively training the initial reward model.

10. The data processing system of claim 1, wherein the generative AI model is a large language model, and the task is summarization, compliance, grounding, dialogue generation, code generation and completion, style transfer, personalized recommendation, data-to-text generation, medical and scientific text generation, translation and multilingual adaptation, question answering, instruction following and task assistance, creative writing, or content generation.

11. A method comprising:
prompting a first generative artificial intelligence (AI) model to label an unlabeled dataset into a plurality of preference pairs based on instructions of a task and one or more preference judgement criteria;
inputting the preference pairs to a second generative AI model;
using the second generative AI model as a based model to generate an initial reward model by modeling reward scores for each of the preference pairs, and generating a reward distribution curve of the initial reward model that ranks each of the preference pairs by a reward score difference of a respective preference pair;
training adapters of the second generative AI model to iteratively train the initial reward model into a last iteration reward model by:
automatically identifying a first portion and a second portion on the reward distribution curve, wherein the first portion includes first pairs that are hard for the first generative AI model to correctly label, and the second portion includes positive pairs ranked higher as compared to the first pairs,
outputting the first pairs in the first portion for human annotations as annotated data,
inputting the annotated data into an improved dataset including the positive pairs in the second portion, and
updating the reward distribution curve for a subsequent iteration reward model based on the improved dataset; and
fine-tuning the first generative AI model by either incorporating the last iteration reward model into a proximal policy optimization (PPO) loop, or inputting an improved dataset associated with the last iteration reward model into a direct preference optimization (DPO) pipeline.

12. The method of claim 11, further comprising:
determining an elbow on a beginning potion of the reward distribution curve that has a positive reward difference of a first predetermined threshold, wherein the second pairs include preference pairs located on and above the elbow on the reward distribution curve.

13. The method of claim 12, further comprising:
determining a knee on an end portion of the reward distribution curve that has a reward difference of a second predetermined threshold, wherein the first pairs include preference pairs located on and below the knee on the reward distribution curve.

14. The method of claim 13, further comprising:
determining a reflection point of the reward distribution curve by reflecting the elbow across an x-axis on the end portion of the reward distribution curve;
flipping preferences for preference pairs in a flipping region between the reflection point and an end of the reward distribution curve as flipped data; and
including the flipped data in the improved dataset, wherein the reward distribution curve is updated based on the improved dataset that further includes the flipped data.

15. The method of claim 11, further comprising:
selecting a random portion of the unlabeled dataset as a sampled dataset,
wherein the preference pairs for generating the reward distribution curve of the reward model are the sampled dataset labelled based on the instructions.

16. A non-transitory computer readable medium on which are stored instructions that, when executed, cause a programmable device to perform functions of:
prompting a first generative artificial intelligence (AI) model to label an unlabeled dataset into a plurality of preference pairs based on instructions of a task and one or more preference judgement criteria;
inputting the preference pairs to a second generative AI model;
using the second generative AI model as a base model to generate an initial reward model by modeling reward scores for each of the preference pairs, and generating a reward distribution curve of the initial reward model that ranks each of the preference pairs by a reward score difference of a respective preference pair;
training adapters of the second generative AI model to iteratively train the initial reward model into a last iteration reward model by:
automatically identifying a first portion and a second portion on the reward distribution curve, wherein the first portion includes first pairs that are hard for the first generative AI model to correctly label, and the second portion includes positive pairs ranked higher as compared to the first pairs,
outputting the first pairs in the first portion for human annotations as annotated data,
inputting the annotated data into an improved dataset including the positive pairs in the second portion, and
updating the reward distribution curve for a subsequent iteration reward model based on the improved dataset; and
fine-tuning the first generative AI model by either incorporating the last iteration reward model into a proximal policy optimization (PPO) loop, or inputting an improved dataset associated with the last iteration reward model into a direct preference optimization (DPO) pipeline.

17. The non-transitory computer readable medium of claim 16, wherein the instructions when executed, further cause the programmable device to perform:
determining an elbow on a beginning potion of the reward distribution curve that has a positive reward difference of a first predetermined threshold, wherein the second pairs include preference pairs located on and above the elbow on the reward distribution curve.

18. The non-transitory computer readable medium of claim 17, wherein the instructions when executed, further cause the programmable device to perform:
determining a knee on an end portion of the reward distribution curve that has a reward difference of a second predetermined threshold, wherein the first pairs include preference pairs located on and below the knee on the reward distribution curve.

19. The non-transitory computer readable medium of claim 18, wherein the instructions when executed, further cause the programmable device to perform:
determining a reflection point of the reward distribution curve by reflecting the elbow across an x-axis on the end portion of the reward distribution curve;
flipping preferences for preference pairs in a flipping region between the reflection point and an end of the reward distribution curve as flipped data; and
including the flipped data in the improved dataset, wherein the reward distribution curve is updated based on the improved dataset that further includes the flipped data.

20. The non-transitory computer readable medium of claim 16, wherein the instructions when executed, further cause the programmable device to perform:
selecting a random portion of the unlabeled dataset as a sampled dataset,
wherein the preference pairs for generating the reward distribution curve of the reward model are the sampled dataset labelled based on the instructions.
